(19) United States
(12) Patent Application Publication
(10) Pub. No.: US 2013/0075155 A1
(43) Pub. Date: Mar. 28, 2013

(54) WIRE PROTECTOR WITH PORTION FOR FIXING ELONGATED OBJECT

(71) Applicants: Hideki Kawai, Yokkaichi-City (JP); Katsunori Hattori, Yokkaichi-City (JP); Tetsuya Yasui, Yokkaichi-City (JP)

(72) Inventors: Hideki Kawai, Yokkaichi-City (JP); Katsunori Hattori, Yokkaichi-City (JP); Tetsuya Yasui, Yokkaichi-City (JP)

(73) Assignee: SUMITOMO WIRING SYSTEMS, LTD., Yokkaichi-City (JP)

(21) Appl. No.: 13/701,923

(22) PCT Filed: Oct. 29, 2010
(86) PCT No.: PCT/JP2010/069293

§ 371 Date: Dec. 4, 2012

(30) Foreign Application Priority Data
Jun. 14, 2010 (JP) 2010-134867

(51) Int. Cl. H01B 17/58

(52) U.S. Cl. CPC H01B 17/58
USPC 174/70 C

(57) ABSTRACT

It is an object to integrate, at low cost, a configuration to maintain a predetermined positional relationship between a wire and an elongated member into a wire protector for protecting the wires. A wire protector with a portion for fixing an elongated object includes a wire protector main unit and a portion for fixing an elongated object. The wire protector main unit is provided with a shape that is capable of accommodating a wire such that the wire is covered, by hot-pressing a non-woven fabric. The portion for fixing an elongated object that is provided with a shape that is capable of holding an elongated object, by hot-pressing a non-woven fabric, and is integrated into one piece with the wire protector main unit.

### BACKGROUND OF THE INVENTION

1. Field of the Invention

The present invention relates to technology to protect wires provided in a vehicle or the like and maintain a predetermined positional relationship between the wires and an elongated object.

2. Description of the Related Art

Conventionally, there is the disclosure of JP 2000-166061A as a technology for attaching a wire harness to a reinforcement.

JP 2000-166061A discloses a clamp made of an gripping portion that grips a wire harness and an elastic gripping portion that elastically grips the reinforcement. Moreover, JP H11-43021A discloses a hose holder for fixing a washer hose unitarily with a wire harness.

Now, a technology has been proposed in which the wire harness is covered by a non-woven fabric, and this non-woven fabric is hot-pressed to form a wire protector. The non-woven fabric is hot-pressed while covering the wire harness and hardens in a state in which it maintains a constant shape, so that it has the function of guiding the path of the wire harness and of protecting the wire harness.

In order to maintain a predetermined positional relationship between the wire harness on which the wire protector is formed and an elongated member, such as a reinforcement, it is necessary to attach a separately manufactured clamp to the wire protector.

However, a clamp as disclosed in JP 200-166061A is a die-molded article that is molded by flowing molten resin at high pressure into a die, so that its manufacturing costs are high. Moreover, in JP H11-43021A, a hose holder is necessary as a separate dedicated fixing component. Therefore, there is the risk that the manufacturing costs of the wire harness provided with the wire protector become high.

Accordingly, it is an object of the present invention to integrate, at low cost, a configuration to maintain a predetermined positional relationship between wires and an elongated member into a wire protector for protecting the wires.

### SUMMARY OF THE INVENTION

In order to solve this problem, a wire protector with a portion for fixing an elongated object according to a first aspect includes a wire protector main unit provided with a shape that is capable of accommodating a wire such that the wire is covered, by hot-pressing a non-woven fabric, and a portion for fixing an elongated object that is provided with a shape that is capable of holding an elongated object, by hot-pressing a non-woven fabric, and is integrated into one piece with the wire protector main unit.

A second aspect is the wire protector with the portion for fixing the elongated object according to the first aspect, wherein the portion for fixing the elongated object includes a pair of holding pieces for sandwiching the elongated object.

A third aspect is the wire protector with the portion for fixing the elongated object according to the second aspect, wherein an outer face of the pair of holding pieces is hardened by hot-pressing, and an inner face of the pair of holding pieces is kept in a state in which it is hardened less than the outer face.

A fourth aspect is the wire protector with the portion for fixing the elongated object according to the second or third aspect, wherein tip portions of the pair of holding pieces each include a portion that is hardened into a shape for retaining the elongated object sandwiched therebetween.

A fifth aspect is the wire protector with the portion for fixing the elongated object according to first aspect, wherein the portion for fixing the elongated object includes a cantilevered holding piece to sandwich the elongated object between the cantilevered holding piece and the wire protection main unit.

According to the first aspect, the portion for fixing the elongated object is provided with a shape that is capable of holding an elongated object by hot-pressing a non-woven fabric, so that compared to a die-molded article made of resin or the like, it can be manufactured at lower cost. Therefore, it is possible to integrate a configuration to maintain a predetermined positional relationship between the wires and the elongated member into the wire protector at low cost.

According to the second aspect, the elongated object can be held with high precision between the pair of holding pieces.

According to the third aspect, the outer face of the pair of holding pieces is hardened, so that the portion for fixing the elongated object can maintain its shape, which is capable of holding an elongated object. Moreover, the inner face of the pair of holding pieces is kept in a state in which it is hardened less than the outer face, so that in a state in which the elongated object is sandwiched between the pair of holding pieces, the elongated object can be maintained reliably in this held state.

According to the fourth aspect, the elongated object can be more reliably prevented from coming off.

According to the fifth aspect, the elongated object can be held such that it is not removed from the wire protector main unit.

### BRIEF DESCRIPTION OF DRAWINGS

FIG. 1 is a perspective view of a wire protector with a portion for fixing an elongated object according to Embodiment 1.

FIG. 2 is a cross-sectional view along line II-II in FIG. 1.

FIG. 3 is a diagram showing a portion for fixing an elongated object of the wire protector with the portion for fixing the elongated object.

FIG. 4 is a diagram showing how an elongated object is fixed to the portion for fixing the elongated object.

FIG. 5 is a diagram showing a manufacturing process of the wire protector with the portion for fixing the elongated object.

FIG. 6 is a diagram showing a manufacturing process of the wire protector with the portion for fixing the elongated object.

FIG. 7 is a diagram showing a pair of holding pieces according to Modified Example 1A.

FIG. 8 is a diagram showing a pair of holding pieces according to Modified Example 1B.

FIG. 9 is a diagram showing a pair of holding pieces according to Modified Example 1C.

FIG. 10 is a diagram showing a pair of holding pieces according to Modified Example 1C.

FIG. 11 is a partial diagram showing a wire protector with a portion for fixing an elongated object according to Embodiment 2.

FIG. 12 is a diagram showing a manufacturing process example of this wire protector with a portion for fixing an elongated object.

FIG. 13 is a diagram showing a cantilevered holding piece according to Modified Example 2A.

FIG. 14 is a diagram showing a cantilevered holding piece according to Modified Example 2B.

FIG. 15 is a diagram showing a cantilevered holding piece and an auxiliary retaining piece according to Modified Example 2C.

FIG. 16 is a perspective diagram showing a cantilevered holding piece according to Modified Example 2D.

FIG. 17 is a diagram showing the cantilevered holding piece according to Modified Example 2D.

FIG. 18 is a diagram showing the cantilevered holding piece according to Modified Example 2D.

FIG. 19 is a partial diagram showing a wire protector with a portion for fixing an elongated object according to Embodiment 3.

### DETAILED DESCRIPTION OF THE PREFERRED EMBODIMENTS

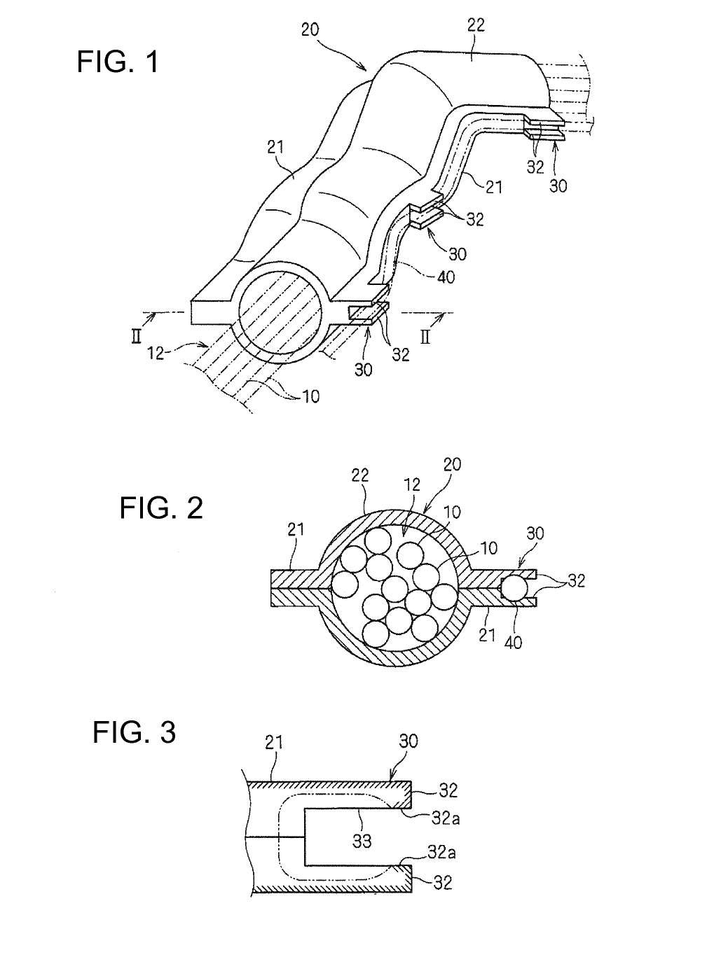

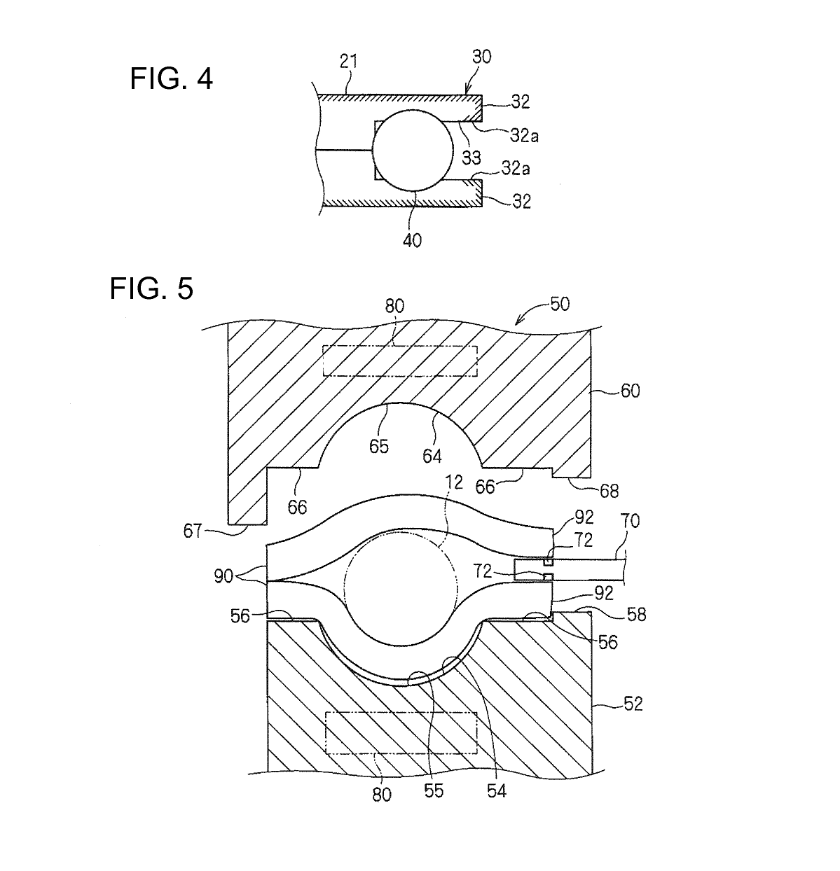

The following is an explanation of a wire protector with a portion for fixing an elongated object according to Embodiment 1. FIG. 1 is a perspective view of a wire protector 20 with a portion for fixing an elongated object, FIG. 2 is a cross-sectional view along line II-II in FIG. 1, FIG. 3 is a diagram showing a portion 30 for fixing an elongated object of the wire protector 20 with the portion for fixing the elongated object, and FIG. 4 is a diagram showing how an elongated object 40 is fixed to the portion 30 for fixing the elongated object.

It should be noted that here, an example is explained, in which a washer hose that supplies a washer liquid in a vehicle is assumed as the elongated object 40 to be fixed. Needless to say, other than a bendable elongated object, such as a washer hose, the elongated object may also be an elongated object that maintains a constant shape, such as a reinforcement provided in the vehicle. Moreover, the wire protector 20 with the portion for fixing the elongated object and the elongated object 40 should be fixed to each other such that they are kept in a predetermined positional relationship, and there may be examples in which the elongated object 40 is fixed to a wire protector 20 with a portion for fixing an elongated object that is fixed in a constant position as well as examples in which a wire protector 20 with a portion for fixing an elongated object is fixed to an elongated object 40 that is fixed in a constant position.

The wire protector 20 with the portion for fixing the elongated object includes a wire protector main unit 22 and portions 30 for fixing the elongated object.

The wire protector main unit 22 and the portion 30 for fixing the elongated object are formed by hot-pressing a non-woven fabric.

For the non-woven fabric, a non-woven fabric may be used that can be hardened by a heating process. As such a non-woven fabric, a non-woven fabric can be used that includes tangled base fibers and an adhesive resin (also referred to as a “binder”). The adhesive resin may be a resin that has a melting point (for example, 110° C.-115° C.) that is lower than the melting point of the base fibers. Moreover, by heating the non-woven fabric to a processing temperature that is lower than the melting point of the base fibers and higher than the melting point of the adhesive resin, the adhesive resin melts and is absorbed between the base fibers. After this, when the non-woven fabric takes on a temperature that is lower than the melting point of the adhesive resin, the adhesive resin is hardened in a state in which the base fibers adhere together. Thus, the non-woven fabric becomes harder than in the state before the heating, and maintains the form into which it was shaped during the heating. Moreover, when a plurality of non-woven fabrics are layered one over the other and then pressed and heated, the molten resin is absorbed into the layered portions of the non-woven fabrics. Thus, the layered non-woven fabrics can be joined together.

The adhesive resin may be granular or fibrous. It may also be constituted by binder fibers in which an adhesive resin layer is formed around core fibers, and the binder fibers are entangled with the base fibers. As the core fibers for this case, it is possible to use the same material as for the base fibers.

For the base fibers, it is possible to use not only resin fibers, but any kind of fibers, as long as they can maintain their fibrous state at the melting point of the adhesive resin. Moreover, it is possible to use, for the adhesive resin, thermoplastic resin fibers that have a melting point that is lower than the melting point of the base fibers. In one example of a combination of base fibers and adhesive resins, resin fibers of PET (polyethylene terephthalate) are taken as the base fibers and a copolymer resin of PET and PEI (polyethylene isophthtalate) is taken as the adhesive resin. In this case, the melting point of the base fibers is about 250° C., and the melting point of the adhesive resin is 110° C.-150° C. Therefore, if the non-woven fabric is heated to a temperature of 110° C.-250° C., the adhesive resin melts, and is absorbed between the base fibers that hold their fibrous state without melting. Moreover, when the non-woven fabric takes on a temperature that is lower than the melting point of the adhesive resin, the adhesive resin hardens while the base fibers are joined together, the non-woven fabric becomes hard, and maintains its form into which it was shaped during the heating.

Moreover, hot-pressing refers to the process of shaping a non-woven fabric by sandwiching the non-woven fabric to be processed between dies and applying pressure to the dies in a heated state. The wire protector main unit 22 and the portions 30 for fixing the elongated object may be formed in one piece by hot-pressing, but they may also be formed separately by hot-pressing. A more specific example of a manufacturing process for manufacturing the wire protector 20 with the portion for fixing the elongated object is explained in more detail further below.

The wire protector main unit 22 is formed into a shape in which it can accommodate wires 10 while covering them.

Here it is assumed that the wires 10 are part of a wire harness that connects various electric devices in a vehicle or the like to each other. There may be a single wire 10 or a plurality of wires 10 to be protected by the wire protector 20 with the portion for fixing the elongated object. Here, an example is explained, where a wire bundle 12 with a plurality of wires 10 is to be protected.

Here, the wire protector main unit 22 has a circular tube shape. Needless to say, the wire protector main unit 22 does not necessarily need to have a circular tube shape but may also have an angular tube shape, or a box shape with suitable openings or the like, as long as it has a shape with which wires can be accommodated. Moreover, the wire protector main unit 22 may be have a tube shape that is bent in accordance with the layout of the wires 10, but it may also have a linear tube shape.

Here, the wire protector main unit 22 is formed by hot-pressing two non-woven fabrics that sandwich the wire bundle 12. For this reason, the inner circumferential wall of the wire protector main unit 22 is in intimate contact with the wire bundle 12 in the form in which the non-woven fabrics are hot-pressed while covering the wire bundle 12. Moreover, on both sides of the wire bundle 12, the edges of the two non-woven fabrics are joined to each other by the heating and compression of the hot-pressing, forming joint edge portions 21. The joint edge portions 21 have the role of maintaining a state in which the wire protector main unit 22 covers the wire bundle 12.

It should be noted that it is also possible that the wires 10 are accommodated inside the wire protector main unit 22 after the wire protector main unit 22 is formed by hot-pressing while not covering the wires 10.

The portions 30 for fixing the elongated object are provided with a shape that can hold an elongated object 40 and are formed in one piece with the wire protector main unit 22.

More specifically, the portions 30 for fixing the elongated object are formed discretely along the longitudinal direction of the wires 10 accommodated in the wire protector main unit 22. Needless to say, a portion 30 for fixing an elongated object may also be formed continuously along the longitudinal direction of the wires 10. That is to say, the portion or portions 30 for fixing the elongated object may have a configuration in which they partially fix and hold the elongated object 40, or a configuration in which they fix and hold the elongated object 40 over its entire longitudinal length. The portion 30 for fixing the elongated object includes a pair of holding pieces 32 that can sandwich the elongated object 40. The pair of holding pieces 32 are formed into substantially rectangular plate-shaped members extending radially outward from the outer circumference of the wire protector main unit 22. Moreover, a space 33 that is open in outward direction of the wire protector main unit 22 and toward both directions in which the wires 10 extend is formed between the pair of holding pieces 32. Thus, with the outward opening of the pair of holding pieces 32, it is possible to arrange the elongated object 40 between the pair of holding pieces 32.

Moreover, the pair of holding pieces 32 are formed by hot-pressing non-woven fabrics, so that they are formed in a plate-shape that can be flexibly deformed. The dimension of the gap between the pair of holding pieces 32, that is, the dimension of the width of the groove 33 is set to be smaller than the dimension of the radius of the portion 30 for fixing the elongated object, which is to be fixed. Consequently, when arranging the elongated object 40 between the pair of holding pieces 32, the elongated object 40 is arranged between the pair of holding pieces 32 while elastically deforming the pair of holding pieces 32 outward. Then, in a state in which the elongated object 40 is sandwiched between the pair of holding pieces 32, the pair of holding pieces 32 hold the elongated object 40 in this sandwiched state by their own elastic restoring force.

Moreover, the outer faces of the pair of holding pieces 32 are hardened by the hot-pressing (see the region marked by slanted lines in FIGS. 3 and 4), and the inner faces of the pair of holding pieces 32 maintain a state in which they are less hardened than the outer faces (see the region enclosed by the dot-dot-dash line in FIG. 3). That is to say, when hot-pressing the pair of holding pieces 32, the inner faces of the pair of holding pieces 32 are not heated, whereas the outer faces of the pair of holding pieces 32 are heated. And since the outer faces of the pair of holding pieces 32 are heated, those outer faces of the pair of holding pieces 32 are hardened, thus achieving that the shape of the pair of holding pieces 32 is maintained. Moreover, at the inner faces of the pair of holding pieces 32, the soft portions where the fibers of the non-woven fabric are entangled are exposed. Therefore, in a state in which the elongated object 40 is sandwiched between the pair of holding pieces 32, the inner faces of the pair of holding pieces 32 are dented into a shape that corresponds to the outer circumferential shape of the elongated object 40 (see FIG. 4). Thus, the elongated object 40 drops out less easily from between the pair of holding pieces 32.

It should be noted that it is sufficient if at the inner faces of the pair of holding pieces 32 the soft portion that clamps the elongated object 40 (in particular the portion in contact with the elongated object 40) is exposed, and the other portions may be hardened by hot-pressing. Here, the inner face tip portions 32a of the pair of holding pieces 32 are hardened by hot-pressing, suppressing an indented deformation following the shape of the elongated object 40. With these inner face tip portions 32a of the pair of holding pieces 32, it is achieved that the elongated object 40 that is sandwiched between the pair of holding pieces 32 is retained.

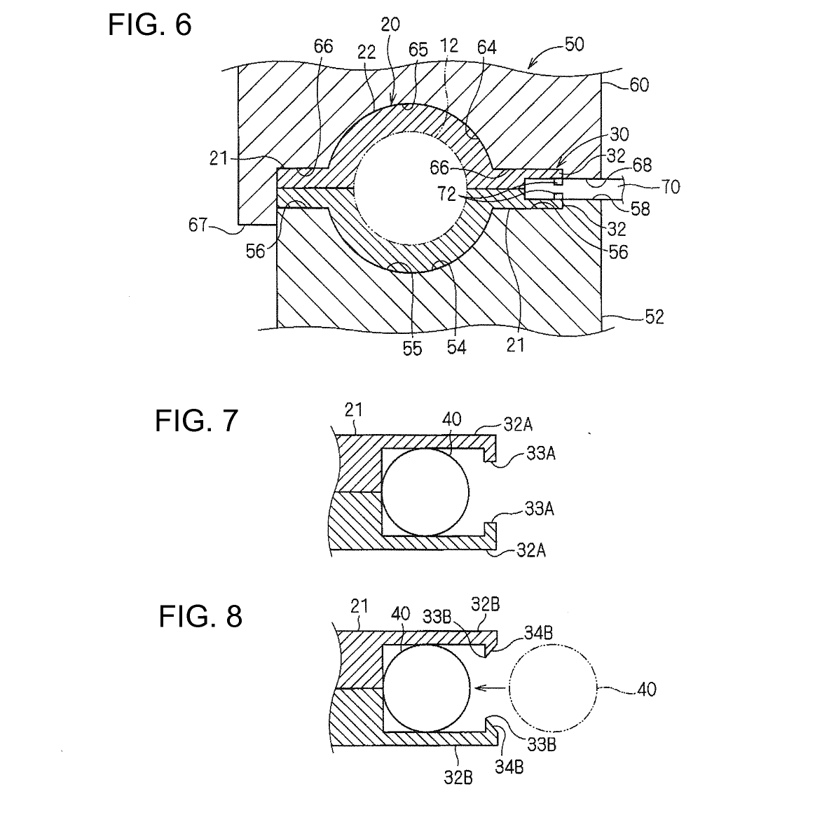

The following is an explanation of one manufacturing example of the wire protector 20 with the portion for fixing the elongated object. Here, an example is explained in which the wire protector main unit 22 and the portion 30 for fixing the elongated object are formed in one piece by continuous non-woven fabrics. FIGS. 5 and 6 are diagrams showing steps for manufacturing the wire protector 20 with the portion for fixing the elongated object.

That is to say, the wire protector 20 with the portion for fixing the elongated object is manufactured using a molding tool 50 for hot-pressing. The molding tool 50 for hot-pressing includes a lower die 52, an upper die 60 and a partitioning member 70.

The lower die 52 is made of metal or the like with excellent thermal conductivity, and is provided with a lower die face 54 on its main face (upper face). The lower die face 54 has a semi-circular groove portion 55 opening upward, and a pair of lateral edge pressure application faces 56 that are arranged at the two lateral edge portions of the semi-circular groove portion 55.

The upper die 60 is an elongated member that is made of metal or the like with excellent thermal conductivity, and is provided with an upper die face 64 on its main face (lower face). The upper die face 64 has a semi-circular groove portion 65 opening downward, and a pair of lateral edge pressure application faces 66 that are arranged at the two lateral edge portions of the semi-circular groove portion 65.

The semi-circular groove portion 65 of the upper die face 64 is arranged in opposition to the semi-circular groove portion 55 of the lower die face 54, and the pair of lateral edge pressure application faces 66 of the upper die face 64 is arranged in opposition to the pair of lateral edge pressure application faces 56 of the lower die face 54.

Moreover, a side wall portion 67 is formed protruding outward on the outward side of one of the lateral edge pressure application faces 66 (the one on the left side in FIGS. 5 and 6) of the upper die 60. Thus, in a state in which the lower die 52 and the upper die 60 are brought close together, as explained below, the outward side of the space between the lateral edge pressure application face 56 on one side and the lateral edge pressure application face 66 on one side is closed by this side wall portion 67.

Moreover, a protruding die portion 58 is formed on the outward side of the lateral edge pressure application face 56 on the other side (right side in FIGS. 5 and 6) of the lower die 52, and a protruding die portion 68 is formed on the outward side of the lateral edge pressure application face 66 on the other side (right side in FIGS. 5 and 6) of the upper die 60. The protruding die portion 58 on the lower die 52 and the protruding die portion 68 on the upper die 60 are arranged in opposition to each other, and the partitioning member 70 is arranged between them.

A heater 80 is provided as a heating device on the lower die 52 and the upper die 60. The heater 80 heats the lower die face 54 and the upper die face 64 to a temperature that is lower than the melting point of the base fibers and higher than the melting point of the adhesive resin. This heater 80 may be embedded in the lower die 52 and the upper die 60, or it may be attached in a heat-transmittable form to the outer faces of the lower die 52 and the upper die 60.

The partitioning member 70 is made of a thermally insulating material, such as a porous ceramic, with a plate-shape whose thickness dimension is the same as the dimension of the width of the groove 33. This partitioning member 70 is placed in that portion of the lower die 52 and the upper die 60 where the portion 30 for fixing the elongated object is formed. By pushing the partitioning member 70 against the portion of the non-woven fabrics where the inner faces of the pair of holding pieces 32 are formed, it is possible to apply pressure to the inner face portions of the pair of holding pieces 32 in an unheated state. It should be noted that portions 72 of the partitioning member 70 that abut against the inner face tip portions 32a of the pair of holding pieces 32 are configured to be heatable. As a configuration for heating these portions 72, it is possible to employ a configuration in which a heater is integrated into the partitioning member 70 and heats the partitioning member 70, or a configuration in which the heat of at least one of the lower die 52 and the upper die 60 is transmitted and heats the partitioning member 70, for example. Moreover, in order to suppress the heating of the non-woven fabrics 90 at the pieces in contact with the partitioning member 70, a configuration may be employed in which the partitioning member 70 is cooled or its heat is dissipated.

The following is an explanation of the procedure of manufacturing the wire protector 20 with the portion for fixing the elongated object using this molding tool 50 for hot-pressing.

First, as shown in FIG. 5, a non-woven fabric 90, the wire bundle 12 and another non-woven fabric 90 are placed on the lower die face 54 of the lower die 52. More specifically, one non-woven fabric 90 is placed on the lower die face 54 of the lower die 52. This non-woven fabric 90 has an elongated sheet shape that can be draped over substantially the entire lower die face 54. Moreover, extension piece portions 92 for forming the portion 30 for fixing the elongated object are formed at the lateral portions of the non-woven fabric 90. The wire bundle 12 is placed on the middle in width direction of this non-woven fabric 90, along the extension direction of the semi-circular groove portion 55 of the lower die face 54, and the other non-woven fabric 90 is laid on top thereof. That is to say, the two non-woven fabrics 90 and the wire bundle 12 are placed on top of the lower die face 54 in a state in which the wire bundle 12 is sandwiched between the two non-woven fabrics 90. At this time, the partitioning member 70 is arranged between the upper and lower extension piece portions 92.

After this, the lower die 52 and the upper die 60 are moved toward each other while the lower die 52 and the upper die 60 are in a heated state, applying pressure to what is between them. Thus, as shown in FIG. 6, while the non-woven fabrics 90, 90 are compressed at a relatively high compression level between the semi-circular groove portions 55 and 65, the non-woven fabrics 90 are heated with the portions in contact with the semi-circular groove portions 55 and 65 at the center. Moreover, on both sides of the wire bundle 12, the lateral edge portions of the pair of non-woven fabrics 90 are heated in a pressurized state by the lateral edge pressure application faces 56 and 66, and thus the lateral edges of the pair of non-woven fabrics 90 are adhered together by the melted adhesive resin, forming the joint edge portions 21. After this, when the non-woven fabrics 90 are cooled, the wire protector main unit 22 hardened around the outer circumferential surface is obtained. Thus, a wire protector main unit 22 is formed that is so difficult to bend that it can maintain the wire bundle 12 in a constant path.

Moreover, in those portions of the upper and lower extension piece portions 92 that abut against the lower die face 54, the upper die face 64 or the heated portions 72 of the partitioning member 70, the adhesive resin in the non-woven fabrics 90 melts sufficiently, so that after cooling down, the melted adhesive resin solidifies and hardens. That is to say, the outer faces, the tip faces and the inner face tip portions 32a of the pair of holding pieces 32 harden. On the other hand, in those portions of the upper and lower extension piece portions 92 that abut against the partitioning member 70, melting of the adhesive resin in the non-woven fabrics 90 is suppressed. Therefore, the hardening of the inner faces of the pair of holding pieces 32 is suppressed, and it is possible to maintain a state in which they are softer than at least the outer faces of the pair of holding pieces 32. Thus, portions 30 for fixing the elongated object are formed that can sandwich and hold the portion 30 for fixing the elongated object.

After this, the lower die 52 and the upper die 60 are moved away from one another, the hot-pressed non-woven fabrics 90 and so on are retrieved from them, and when the partitioning member 70 is removed, the wire protector 20 with portions for fixing the elongated object is obtained. The cooling after the hot-pressing may be carried out while the non-woven fabrics 90 are still between the lower die 52 and the upper die 60, but it may also be carried out after retrieving them from between the lower die 52 and the upper die 60.

It should be noted that in the present embodiment, the portions 30 for fixing the elongated object are formed discretely along the longitudinal direction of the wire protector 20 with the portion for fixing the elongated object. Therefore, at portions other than those where the portions 30 for fixing the elongated object are to be formed, the partitioning member 70 or the like is omitted, and the lower die face 54 and the upper die face 64 are provided with a shape that can form the joint edge portions 21 without the portions 30 for fixing the elongated object.

With the wire protector 20 with the portion for fixing the elongated object configured as described above, the portions 30 for fixing the elongated object are provided with a shape that can hold the elongated object 40 by hot-pressing the non-woven fabrics 90. Therefore, compared to ordinary resin molded articles that are die-molded by feeding a molten resin at relatively high resin pressure, the portions 30 for fixing the elongated object can be manufactured at lower cost. Consequently, a configuration in which an elongated object 40, such as a washer hose, and wires 10 are held in a predetermined positional relationship can be obtained at low cost.

Moreover, since with this configuration, the elongated object 40 is sandwiched and fixed between the pair of holding pieces 32, the elongated object can be held with high precision in the width direction of the pair of holding pieces 32.

Moreover, since the outer faces of the pair of holding pieces 32 are hardened, it is possible to maintain the portions 30 for fixing the elongated object in a shape in which they can hold the elongated object 40. At the same time, since the inner faces of the pair of holding pieces 32 are maintained in a state in which they are less hardened than the outer faces, the elongated object 40 does not easily come off from the state in which it is sandwiched between the pair of holding pieces 32, and the holding state of the elongated object 40 can be maintained reliably.

What is more, since the inner face tip portions 32a of the pair of holding pieces 32 are hardened, it is possible to suppress deformation of the inner face tip portions 32a, and thus the elongated object 40 can be reliably kept from coming off.

Moreover, since the wire protector main unit 22 and the portions 30 for fixing the elongated object are formed in one piece with the continuous non-woven fabrics 90, the wire protector main unit 22 and the portions 30 for fixing the elongated object can be manufactured easily and in little time.

The following is an explanation of Modified Examples 1A to 1C based on the foregoing embodiment.

In the Modified Example 1A shown in FIG. 7, a pair of holding pieces 32A corresponding to the pair of holding pieces 32 is provided. The pair of holding pieces 32A has a configuration in which the entire inner faces and outer faces are hardened by heating. It should be noted that such hardening also of the inner faces of the pair of holding pieces 32A can be realized by using a partitioning member that can be heated by a heater or the like. Moreover, the tip portion of the pair of holding pieces 32A is provided with stopper portions 33A that protrude inwardly. Also these stopper portions 33A are formed by hardening the non-woven fabrics 90 by hot-pressing. The dimension of the gap between the pair of holding pieces 32A may be the same as that of the diameter of the portions 30 for fixing the elongated object, but it may also be different. However, the dimension of the gap between the opposing stopper portions 33A is smaller than the diameter of the of the portions 30 for fixing the elongated object. Consequently, in a state in which the elongated object 40 is inserted into and fixed between the pair of holding pieces 32A, the stopper portion 33A retains the elongated object 40.

In the Modified Example 1B shown in FIG. 8, a pair of holding pieces 32B corresponding to the pair of holding pieces 32 is provided. The tip portion of the pair of holding pieces 32B is provided with stopper portions 33B that protrude inwardly. The faces of the stopper portions 33B that are on the tip side in the direction in which the pair of holding pieces 32B extend are provided with guide faces 34B that are slanted outward toward the tip side. Thus, when the elongated object 40 is inserted between the pair of holding pieces 32B, the pair of holding pieces 32B can be easily opened outward by pushing the elongated object 40 against the guide faces 34B. Thus, it becomes easy to carry out the operation of sandwiching the elongated object 40 between the pair of holding pieces 32B.

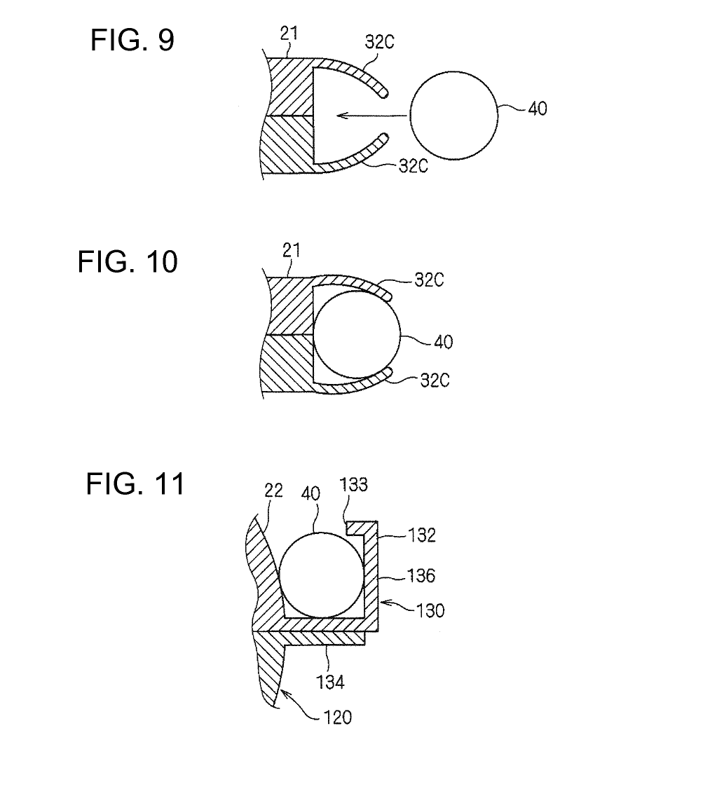

In the Modified Example 1C shown in FIGS. 9 and 10, a pair of holding pieces 32C corresponding to the pair of holding pieces 32 is provided. This pair of holding pieces 32C has a configuration in which all of its inner faces and outer faces are hardened by heating. Moreover, the pair of holding pieces 32C is provided with a plate shape that is bent inward from the outside, and the dimension of the gap between the pair of holding pieces 32C is formed such that it gradually becomes smaller from the base ends towards the tips. It should be noted that the dimension of the gap between the tips of the pair of holding pieces 32C is smaller than the diameter of the elongated object 40. Thus, when the elongated object 40 is placed between the pair of holding pieces 32C through the tips of the pair of holding pieces 32C, the elongated object 40 is sandwiched and held by being embraced by the pair of holding pieces 32C. That is to say, the inwardly slanted tip portions of the pair of holding pieces 32C function as portions that are hardened into a shape that retains the elongated object 40.

The following is an explanation of a wire protector with a portion for fixing an elongated object according to Embodiment 2. FIG. 11 is a partial diagram illustrating a wire protector 120 with a portion for fixing an elongated object according to Embodiment 2.

In the wire protector 120 with the portion for fixing the elongated object according to Embodiment 2, a portion 130 for fixing the elongated object corresponding to the portion 30 for fixing the elongated object includes a cantilevered holding piece 132 that is capable of sandwiching the elongated object 40 together with the wire protector main unit 22. It should be noted that the explanations for this Embodiment 2 focus on the differences to the above-described Embodiment 1, and structural features that are the same as in Embodiment 1 are given the same reference numerals and not explained again.

The cantilevered holding piece 132 is formed by letting at least one of the non-woven fabrics protrude further outward to the side of the wire protector main unit 22 and hot-pressing it. Here, the cantilevered holding piece 132 includes a bottom portion 134 and a sandwiching piece 136. The bottom portion 134 is provided with a plate shape that protrudes from the outer side of the wire protector main unit 22. Here, the bottom portion 134 is formed by a portion that is joined together by heating the pair of non-woven fabrics. Moreover, the sandwiching piece 136 is formed extending in an L-shape from the bottom portion 134. Here, the sandwiching piece 136 is formed by extending at least one of the non-woven fabrics further than the bottom piece 134, and hot-pressing it in a state in which it forms an L-shape with respect to the bottom portion 134. Moreover, the tip of the sandwiching piece 136 is provided with a stopper portion 133 that protrudes to the side of the wire protector main unit 22. Like the bottom portion 134 and the sandwiching piece 136, also the stopper portion 133 is formed by hardening the non-woven fabric 90 by hot-pressing.

The dimension of the gap between the sandwiching piece 136 and the outer circumferential surface of the wire protector main unit 22 may be the same as that of the diameter of the portion 30 for fixing the elongated object, but it may also be different. However, the dimension of the gap between the tip of the stopper portion 133 and the outer circumferential surface of the wire protector main unit 22 is smaller than the diameter of the of the portion 30 for fixing the elongated object. Consequently, when the elongated object 40 is inserted into and fixed between the sandwiching piece 136 and the wire protector main unit 22, the stopper portion 133 retains the elongated object 40.

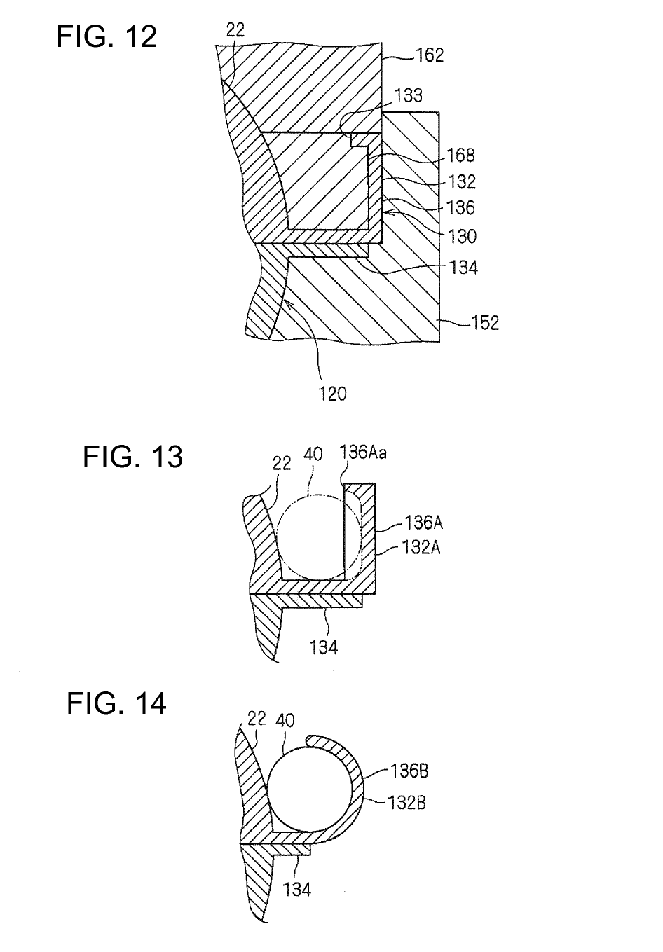

Such a cantilevered holding piece 132 can be formed easily in one piece together with the wire protector main unit 22 for example by using an intermediate die 168 forming the inner face of the cantilevered holding piece 132, as shown in FIG. 12.

That is to say, as the lower die 152 and the upper die 162, dies are prepared that have die faces that can form the down-facing faces and the up-facing faces of the wire protector main unit 22 and the cantilevered holding piece 132. And as the intermediate die 168, a block-shaped or rod-shaped die is prepared that can form the inner faces of the cantilevered holding piece 132. Also this intermediate die 168 can apply heat to the non-woven fabric contacting it, either by receiving the heat from the upper die 162 or the like or with a heating means that is incorporated into it. When hot-pressing the wire protector main unit 22 with the pair of non-woven fabrics 90, the lateral portions of the non-woven fabrics 90 are partially extended outward, and by heating these extended portions sandwiched between the various die faces of the intermediate die 168, the lower die 152 and the upper die 162, it is possible to form the sandwiching piece 136. It should be noted that the heated intermediate die 168 can be pulled out in the longitudinal direction of the wire protector main unit 22, or can be removed by elastically deforming the cantilevered holding piece 132.

With a wire protector 120 with a portion for fixing an elongated object configured in this manner, it is possible to attain the same effects as with the above-described Embodiment 1.

In particular, since the portion 130 for fixing the elongated object has the cantilevered holding piece 132 sandwiching the elongated object 40 together with the wire protector main unit 22, the elongated object 40 can be held so that it is in contact the outer peripheral surface of the wire protector main unit 22 and stays in contact therewith. Therefore, this arrangement is suitable for cases in which a soft elongated object 40 is fixed along the wire protector main unit 22 at a bent portion of the wire protector main unit 22.

The following is an explanation of Modified Examples 2A to 2D based on the foregoing embodiment.

In the Modified Example 2A shown in FIG. 13, a cantilevered holding piece 132A corresponding to the above-described cantilevered holding piece 132 is provided. The cantilevered holding piece 132A includes a sandwiching piece 136A corresponding to the above-described sandwiching piece 136. The inner face of this sandwiching piece 136A is not hardened by heating, and thus takes on a soft quality of the tangled fibers of the non-woven fabric (see region enclosed by dot-dot-dash line in FIG. 13). Moreover, the inner face tip portion 136Aa of the sandwiching piece 136A is hardened by heating. Also, the dimension of the gap between the sandwiching piece 136A and the wire protector main unit 22 is set to be smaller than the dimension of the diameter of the elongated object 40. Therefore, in a state in which the elongated object 40 is sandwiched between the wire protector main unit 22 and the sandwiching piece 136A, the inner face of the sandwiching piece 136A is dented into a shape that corresponds to the outer circumferential shape of the elongated object 40 (see FIG. 13). Thus, the elongated object 40 drops out less easily from between the wire protector main unit 22 and the sandwiching piece 136A. And moreover, since the inner face tip portions 136Aa of the sandwiching piece 136A is hardened, it is possible to suppress deformation of the inner face tip portion 136Aa, and thus the elongated object 40 can be reliably kept from coming off.

In the Modified Example 2B shown in FIG. 14, a cantilevered holding piece 132B corresponding to the above-described cantilevered holding piece 132 is provided. The cantilevered holding piece 132B includes a sandwiching piece 136B corresponding to the above-described sandwiching piece 136. The sandwiching piece 136B is formed into an arc-shaped curved plate shape, and preferably an arc-shaped curved plate shape whose diameter is the same or smaller than the diameter of the elongated object 40. Thus, when the elongated object 40 is inserted between the outer circumference of the wire protector main unit 22 and the sandwiching piece 136B, the arc-shaped inner face of the sandwiching piece 136B embraces the outer circumference of the elongated object 40, and thus the elongated object 40 is held such that it does not come off. In other words, the tip portion of the sandwiching piece 136B that is slanted inward functions as a portion that is hardened into a shape that retains the elongated object 40.

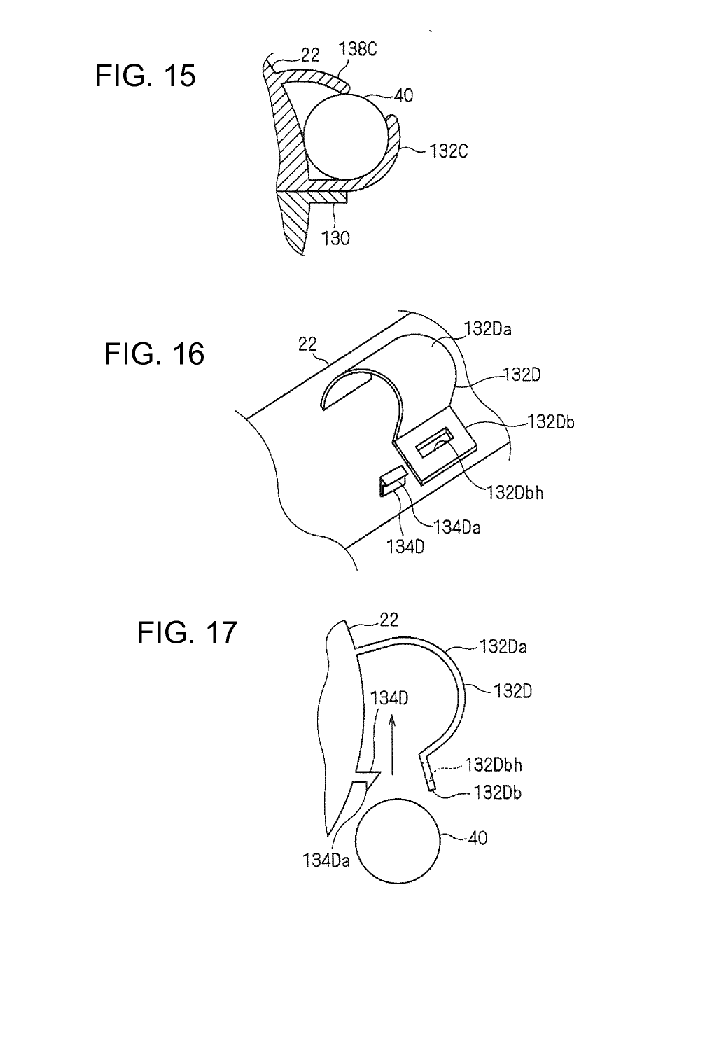

In the Modified Example 2C shown in FIG. 15, an auxiliary retaining piece 138C is added to the Modified Example 2B. That is to say, the auxiliary retaining piece 138C protrudes out from the outer circumference of the wire protector main unit 22, partially closing the gap between the outer circumference of the wire protector main unit 22 and the tip of the sandwiching piece 136B. The auxiliary retaining piece 138C is formed with an arc-shaped curved plate shape, and extends toward the tip of the sandwiching piece 136B. Moreover, when the elongated object 40 is inserted and placed between the outer circumference of the wire protector main unit 22 and the sandwiching piece 136B, the tip of the auxiliary retaining piece 138C abuts against the elongated object 40, keeping the elongated object 40 from coming off. The auxiliary retaining piece 138C may be made by hot-pressing a portion of the non-woven fabrics forming the wire protector main unit 22, or may be made by fixing a separate hot-pressed non-woven fabric with an adhesive or the like. In that case, the length dimension of the sandwiching piece 136B may be shorter than that in the Modified Example 2B.

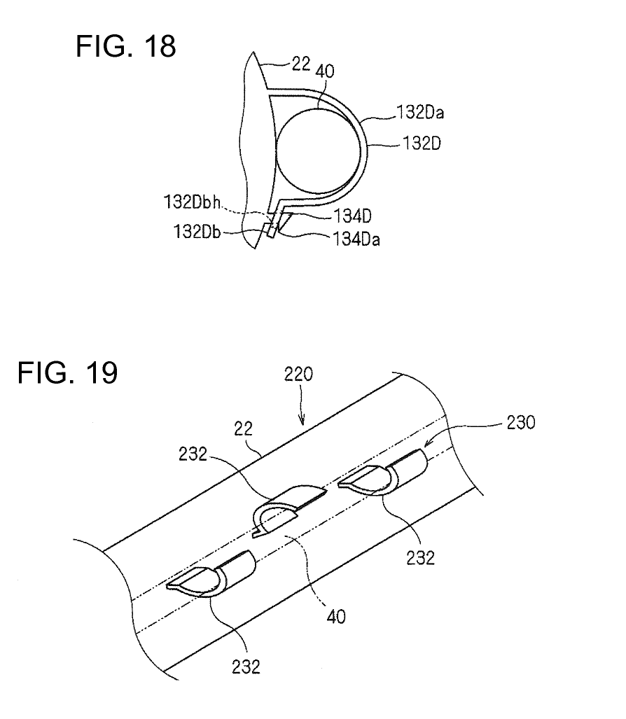

In the Modified Example 2D shown in FIGS. 16 to 18, a cantilevered holding piece 132D corresponding to the above-described cantilevered holding piece 132 is provided. The cantilevered holding piece 132D includes an embracing portion 132Da and a locking piece portion 132Db. The embracing portion 132Da is formed with an arc-shape that corresponds to the outer circumferential shape of the elongated object 40, and its base end portion is fixed to the outer circumference of the wire protector main unit 22. Moreover, the locking piece portion 132Db is provided at the tip of the embracing portion 132Da. An engaging hole 132Dbh that is capable of engaging a locking portion 134D, which is explained later, is formed in the locking piece portion 132Db. The locking portion 134D is provided at a position on the outer circumference of the wire protector main unit 22, opposite from the tip portion of the embracing portion 132Da. The locking portion 134D protrudes on the opposite side with respect to the cantilevered holding piece 132D and includes a protruding portion 134Da whose height becomes gradually smaller towards the tip side of the locking portion 134D. In a state in which the elongated object 40 is arranged between the outer circumference of the wire protector main unit 22 and the embracing portion 132Da, the locking portion 134D is inserted into the engaging hole 132Dbh of the locking piece portion 132Db, engaging the circumferential edge of the engaging hole 132Dbh with the protruding portion 134Da. Thus, a state is maintained in which the elongated object 40 is fixed between the outer circumference of the wire protector main unit 22 and the embracing portion 132Da (see FIG. 18).

The locking portion 134D may be made by hot-pressing a portion of the non-woven fabrics forming the wire protector main unit 22, or may be made by fixing a separate hot-pressed non-woven fabric with an adhesive or the like.

The following is an explanation of a wire protector with a portion for fixing an elongated object according to Embodiment 3. FIG. 19 is a partial diagram illustrating a wire protector 220 with a portion for fixing an elongated object according to Embodiment 3.

In the wire protector 220 with the portion for fixing the elongated object according to Embodiment 3, a portion 230 for fixing an elongated object corresponding to the portion 30 for fixing the elongated object includes a plurality of alternating holding pieces 232. It should be noted that the explanations for this Embodiment 3 focus on the differences to the above-described Embodiment 1, and structural features that are the same as in Embodiment 1 are given the same reference numerals and not explained again.

That is to say, a plurality of the alternating holding pieces 232 are arranged in longitudinal direction of the wires 10, which are accommodated in the wire protector main unit 22 (indicated by solid lines in FIG. 19). There are gaps in longitudinal direction of the wires 10 between the alternating holding pieces 232, but it is also possible to provide a continuous holding piece without gaps. Moreover, the elongated object 40 can be fixed by tucking the elongated object between neighboring alternating holding pieces 232 so that the neighboring alternating holding pieces 232 contact the elongated object 40 from opposite sides. Here, the alternating holding pieces 232 have an arc-shaped plate shape adapted to the shape of the outer circumference of the elongated object 40. Moreover, the inner side faces of the alternating holding pieces 232 face toward opposite sides along the longitudinal direction of the wires 10. Thus, the elongated object 40 is placed such that the inner circumferential face of the alternating holding pieces 232 contact the outer circumferential face alternatingly along the longitudinal direction of the elongated object 40. Thus, the elongated object 40 is held by the plurality of alternating holding pieces 232. It is preferable that there are at least three alternating holding pieces 232.

With this embodiment, it is possible to hold the elongated object 40 with the plurality of holding pieces 232, and to obtain the same effects as with the above-described Embodiment 1.

Moreover, the alternating holding pieces 232 themselves have a relatively simple shape, so that they are easy to form in one piece with the wire protector main unit 22, even without a partitioning member or an intermediate die.

It should be noted that it is sufficient if the alternating holding pieces 232 have a shape in which they can come in contact with one side of the elongated object 40, and it is possible to employ, for example, the shape of the holding piece 32, 32A, 32B or 32C on one side in Embodiment 1.

It should be noted that the portions 30, 130, 230 for fixing the elongated object described in the foregoing embodiments and modified examples may be formed in one piece with the wire protector main unit 22, but they may also be joined to the wire protector main unit 22 by forming them separately from the wire protector main unit 22 and affixing them afterwards.

As an example of the former, as explained above, it is possible to configure the wire protector main unit 22 and the portions 30, 130, 230 for fixing the elongated object in one piece from continuous non-woven fabrics. In this case, it is possible to form the portion 30 for fixing the elongated object at the same time as the wire protector main unit 22, and it is possible to manufacture the wire protector 20 with the portion for fixing the elongated object in short time.

As an example of the latter, it is possible to mold the various structural portions of the portions 30, 130, 230 for fixing the elongated object by hot-pressing separate non-woven fabrics, and to affix them to the wire protector main unit 22. This affixing may be accomplished by sandwiching a portion of the pre-formed portion 30, 130, 230 for fixing the elongated object between portions of a pair of non-woven fabrics that are joined together by heating and pressing, and using the adhesive resin included in the non-woven fabric to join them together, or by laser welding, resistance welding, thermal welding or gluing with an adhesive.

In this case, since the portion 30, 130, 230 for fixing the elongated object is formed separately, the portion 30, 130, 230 for fixing the elongated object can be manufactured easily, even if it has a relatively complex shape.

It should be noted that the configurations explained in the above-explained embodiments and modified examples can be combined as suitable, provided that they do not contradict each other.

The foregoing explanations are in all aspects examplary and not meant to limit the invention. It will be understood that numerous modifications not specified here can be conceived that do not exceed the scope of the invention.

1. A wire protector with a portion for fixing an elongated object, comprising:
a wire protector main unit provided with a shape that is capable of accommodating a wire such that the wire is covered, by hot-pressing a non-woven fabric, and
a portion for fixing an elongated object that is provided with a shape that is capable of holding the elongated object, by hot-pressing a non-woven fabric, and is integrated into one piece with the wire protector main unit.

2. The wire protector with the portion for fixing the elongated object according to claim 1,
wherein the portion for fixing the elongated object includes a pair of holding pieces for sandwiching the elongated object.

3. The wire protector with the portion for fixing the elongated object according to claim 2,
wherein an outer face of the pair of holding pieces is hardened by hot-pressing, and an inner face of the pair of holding pieces is kept in a state in which it is hardened less than the outer face.

4. The wire protector with the portion for fixing the elongated object according to claim 3,
wherein tip portions of the pair of holding pieces each include a portion that is hardened into a shape for retaining the elongated object sandwiched therebetween.

5. The wire protector with the portion for fixing the elongated object according to claim 1,
wherein the portion for fixing the elongated object includes a cantilevered holding piece to sandwich the elongated object between the cantilevered holding piece and the wire protection main unit.

6. The wire protector with the portion for fixing the elongated object according to claim 3,
wherein tip portions of the pair of holding pieces each include a portion that is hardened into a shape for retaining the elongated object sandwiched therebetween.
